(19) United States
(12) Patent Application Publication
(10) Pub. No.: US 2008/0137669 A1
(43) Pub. Date: Jun. 12, 2008

(54) NETWORK OF NODES

(75) Inventors: Elena Balandina, Helsinki (FI); Sergey Balandina, Helsinki (FI); Michel Gillet, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/609,829

(22) Filed: Dec. 12, 2006

(51) Int. Cl. H04L 12/56

(52) U.S. Cl. 370/400

(57) ABSTRACT

A network of nodes comprising a plurality of nodes, at least one node being connected to at least one other node, wherein a link between two nodes is classified as supporting reliable class traffic, as supporting unreliable class traffic or as supporting both reliable class traffic and unreliable class traffic.

### FIELD OF THE INVENTION

The present invention relates to a network of nodes and a method of routing traffic in a network from a source node to a destination node via at least one node as well as a transmitting node.

### BACKGROUND TO THE INVENTION

Known communication environments can be quite varied. For example, within a single device or entity, there may be communications between different functionalities or nodes within that device. Alternatively, two or more devices may be connected together and there may be communications between two or more of the devices. It is known to have two devices communicating with each other via one or more other devices such as in the context of a packet data network, a mobile communications network or the like.

In the context of this document a node can mean functionalities within a single device or a device itself.

A number of situations in communication environments provide “reliability guarantees”. For example it may be guaranteed that all data sent by one node is received by a second node. To achieve this, the second node may be arranged to provide an acknowledgement. In the absence of an acknowledgement or if there is an indication that the data has been incorrectly received, then the data is resent. When considering the impact of this reliability guarantee on the performance or the behaviour of applications, a number of issues have to be taken into consideration. From a first consideration of this, it might be considered that reliability guarantees are a desirable characteristic. However, the inventors have noted that on further analysis, in many cases the provision of reliability might cost too much and be unacceptable for many applications. “Cost” means the direct cost of deploying the reliability mechanisms, and/or its impact on the end-to-end performance of the application (e.g. increase of latency, jitter, increased use of resources, and reduction in capacity etc.).

In sensor networks and networks on terminals, the end-to-end reliability of connections is achieved by transmitting data over a sequence of point-to-point reliable links, which is a result of the specific features of these network types. A point-to-point connection is a single link and is limited to the L2 layer of a protocol stack (as described in more detail later). Thus only two nodes connected to the same link can communicate. End-to-end refers to the communication between two end nodes with one or more relay nodes in between. L3 and L4 layers of the protocol stack are responsible for this level of communication, that is at the network/transport level.

The inventors have recognised that there is a problem in that end-to-end reliability is provided by the link level, and the connections do not have the choice to be reliable or non-reliable. In the simplest situation, for a reliable connection a check is made to see if the data has been correctly received and if not the data is resent, whereas for an unreliable connection no such check or resending is carried out. For example, according to the current MIPI (Mobile Industry Processor Interface) proposal, all links are reliable. A given streaming application may not be able to tolerate the additional latency and jitter variation which is caused by the replay of data in order to achieve the required reliability. One way to solve this problem is by having extra buffering at the receiver side and by regularly introducing artificial delays in application data transmission. The solution is disadvantageous because additional circuitry is required, a delay is introduced, and memory resources are needed. One difference between reliable and non-reliable links is the provided set of quality of service guarantees for the data flow. The reliable flows are consistently guaranteed, that is no packet drops, but which is achieved at the cost of degradation of some other “guarantees” such as bandwidth overprovision—with the use of correction codes, or with error detection and data retransmission.

The inventors have appreciated that in for example, some sensor networks, some links are reliable and some are not. The prior art merely tries to make the unreliable links reliable (for example, by introducing protocol-layer error detection and retransmissions) which may cause the problems set out above.

Reference is now made below to some patent applications which describe some known arrangements.

US20060083251 describes a route control method. In generation of an MPLS (multi Protocol Label Switching) path which extends over plural routing areas or in the generation of a GMPLS (Generalized MPLS) path of a single routing area, a path originating node cannot conduct route computation of the whole path. Therefore, where plural paths are generated, there is a problem that reliability and communication quality cannot be secured. In a label switch path generation processing intended for MPLS and GMPLS networks, a path originating node is provided with a unit for setting restricted link information in a label allocation request message and sending it, and a node having received the label allocation request message is provided with a unit for selecting another route, which does not pass through the restricted link according to the restricted link information, and generating a path.

In DE10147909 there is disclosed a routing method for making connections between end users of mobile communication networks according to selected criteria, such as least-cost connection, quality, capacity, reliability, etc. The method has the following steps: making a connection from an end user terminal to a communications network operator system; routing of a communications connection from the operator system to a service provider system; provision of target data from the end user terminal; and routing of the communication connection to the target of the service provider system based on the target identifying data.

GB2338876 discloses an integrated information communication system without using dedicated lines or the Internet. The system is comprised of an access control apparatus for connecting a plurality of computer communication networks or information communication equipment (e.g. LANs—local area networks), and a relay device for networking the aforementioned access control apparatus, the system having functions for performing routing by transferring information by a unified address system, and is configured such that the aforementioned plurality of computer communication networks or information communication equipment can perform communications in an interactive manner

WO200276038 discloses a method for guaranteeing quality of service on the internet by routing data along nodes without error correction processing capability. This method routes all data (e.g. IP packets/ATM cells) between source and destination only along non-blocking links of router nodes on the Internet without data portion checksum processing at the nodes (e.g. using Real time Streaming Protocol IPv4 UDP packet type with checksum disabled; or as IPv6 specified hop UDP packets which has checksum included in the data portion but routed only along cut-through router/switches). The IP Packet is sent without error correction checksum in the data portion, or the nodes along the route do not perform any error controls on the data portions of the IP Packets/ATM cells. Hence there will not be any IP Packets/ATM cells retransmission occurring along the route. IP Packets/ATM Cells with Header portion checksum errors detected could simply be discarded.

A real-time communications system for decentralized management is disclosed in EP1006694. To achieve this, the following techniques are employed: (1) Overtaking of communication packets based on priority; (2) Path control based on the priority; and (3) Priority change at each node. When carrying out real-time communication between a plurality of information processors, each communication node (information processor) carries out overtaking of the communication packets in accordance with the priority. In the course of this, each communication node can change the priority, and establish different paths for each of the priority.

U.S. 68323005 discloses link adaptation in wireless networks for throughput maximization under retransmissions.

In US20040111652, there is disclosed a configurable reliable messaging system. The configurable reliable messaging system comprises a communication subsystem capable of transmitting and receiving a message across a network using at least one of a plurality of network links, a plurality of internet protocols and a plurality of transport protocols. The configurable reliable messaging system also comprises a reliability subsystem capable of configurably logging the message, detecting a plurality of failures, notifying a remote entity interconnected with the configurable reliable messaging system via the network of the plurality of failures, and recovering from the plurality of failures. In addition, the configurable reliable messaging system comprises a control module capable of configuring the communication subsystem and the reliability subsystem based on a set of input parameters.

### SUMMARY OF INVENTION

It is an aim of some embodiments of the invention to address at least one of the above described problems.

According to one aspect of the invention, there is provided a network of nodes comprising: a plurality of nodes, at least one node being connected to at least one other node, wherein a link between two nodes is classified as supporting reliable class traffic, as supporting unreliable class traffic or as supporting both reliable class traffic and unreliable class traffic.

According to another aspect of the invention, there is provided a transmitting node, said transmitting node arranged in use to be connected to a receiving node with a reliable link therebetween, said transmitting node comprising a processor configured to suppress retransmission of data to said receiving node.

According to another aspect of the invention, there is provided a method of routing traffic in a network from a source node to a destination node via at least one node, each node being connected to at least one other node by a connection, wherein each connection is classified as supporting a first type of communication, a second type of communication or both the first type of communication and the second type of communication, said method comprising: defining a routing table comprising information defining a plurality of paths between said source and destination nodes, said information defining for each path if said path comprises connections supporting the first type of communications, the second type of communications or both first and second type of communications.

According to another aspect of the invention, there is provided a method comprising: transmitting to a receiving node via a reliable link node, suppressing, in response to a determination that the transmitting has not been successful, retransmission of data to said receiving node.

According to another aspect of the invention, there is provided a node comprising: a first subunit configured to decide on a reliability required on a flow; a second subunit configured to provide a reliable flow treatment; and a third subunit configured to provide a non-reliable flow treatment, wherein said first subunit is configured to provide a received flow either to the first subunit or the second subunit in dependence on a decision made by the first subunit on the required reliability.

According to another aspect of the invention, there is provided a method comprising: deciding on a reliability required on a flow; if, the flow requires a reliable flow treatment, providing a reliable flow treatment; and if the flow requires a non-reliable flow treatment providing a non-reliable flow treatment.

According to another aspect of the invention, there is provided a computer readable medium comprising: computer executable components for defining a routing table comprising information defining a plurality of paths between source and destination nodes via at least one node, each node being connected to at least one other node by a connection, wherein each connection is classified as supporting a first type of connection, a second type of connection or both a first type of connection and a second type of connection, said information defining for each path if said path comprises first connections, second connections or both first and second connections.

The inventors have recognised that in some embodiments of the invention, a network needs a mechanism to allow an end to end connection to be reliable or not with maximum utilization of features of the underlying links. A lack of a flexible method for setting reliability status of the connections in the targeted network types is a drawback of some known arrangements. This is addressed by some embodiments of the invention

### BRIEF DESCRIPTION OF DRAWINGS

For a better understanding of the present invention and as to how the same may be carried into effect, reference will now be made by way of example only to the accompanying drawings in which:

FIG. 1 shows a schematic view of a sensor network in which embodiments of the present invention may be incorporated;

FIG. 2 shows a schematic view of a mobile communications device in which embodiments of the present invention may be incorporated;

FIG. 3 shows a protocol stack used by in node in which embodiments of the present invention may be used;

FIG. 4 schematically shows an arrangement comprising two nodes, connected together, in which embodiments of the present invention may be incorporated;

FIG. 5 schematically shows a network in which embodiments of the invention may be incorporated, with reliable and non-reliable connections;

FIG. 6 shows a traffic flow in an embodiment of the present invention;

FIG. 7 shows a transmitting node in an embodiment of the present invention; and

FIG. 8 shows schematically the functionality of a transmitting node in one embodiment of the invention.

### DETAILED DESCRIPTION OF EMBODIMENTS OF THE INVENTION

In some embodiments of the present invention, the principles of providing end-to-end reliability on top of point-to-point reliability of the underlying links are used. In some embodiments of the invention, a mechanism is provided for flexible management of the reliability status of the end-to-end connections and maximizing utilization efficiency of the underlying resources that is of the end point nodes and any intermediate nodes. Embodiments of the invention can be used in networks that need flexibility in defining reliability status of the End-to-End (E2E) connections, where E2E reliability is created on top of the link level Point-to-Point (P2P) reliability. Embodiments of the invention may provide a way of managing E2E connection reliability status, for the networks with P2P reliable and non-reliable links. Embodiments of the present invention may provide a mechanism for efficient load distribution in the network.

Depending on the application and use scenario, the E2E connection might need to be reliable or non-reliable, and under certain circumstances the reliability status may have to be changed. For example, some applications under normal conditions will benefit if E2E reliability is provided for “free” (based on P2P reliability of the underlying links), however when it comes for a cost of an additional delay (e.g., due to a line block somewhere on the path) or traffic jam (e.g., due to head of line blocking), etc., many applications (e.g. streaming applications) would prefer an unreliable mode.

Embodiments of the present invention may have a wide range of applications. One application of embodiments of the present invention is in a sensor network where both reliable and non-reliable treatment of the traffic is required.

A sensor network embodying the invention may use relatively simple principles that would increase efficiency of the underlying resource utilization and allow the meeting of Quality of Service (QoS) requirements associated with the data flows. One of the criteria that can be used for this purpose is a reliability requirement for the data transmission.

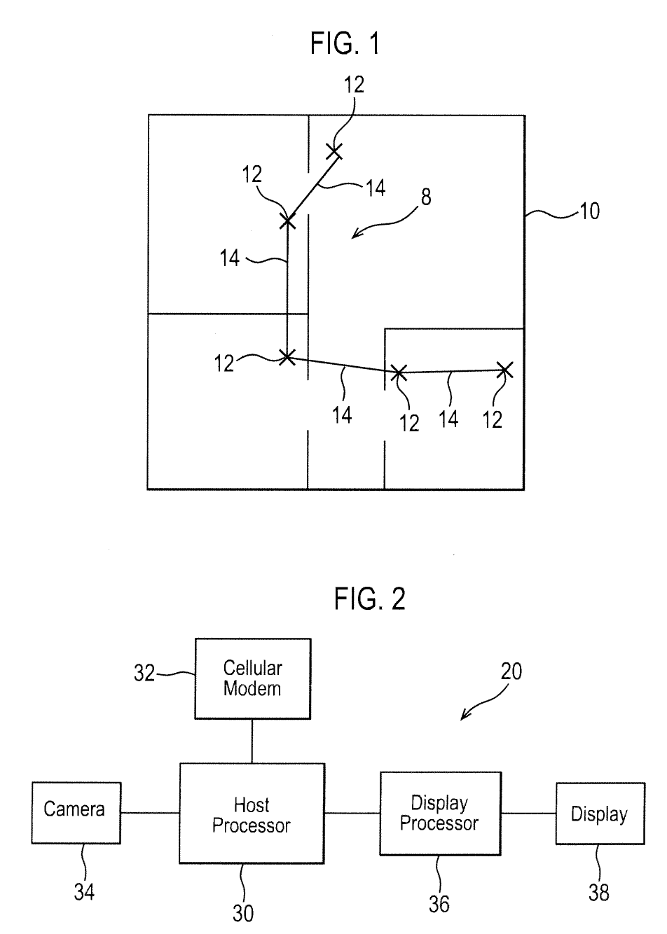

One example of a sensor network is shown in FIG. 1. In this embodiment a sensor network 8 is provided in a house 10. In each room of the house, one or more sensors 12 are provided. These sensors could be a temperature sensor, a light sensor, a humidity sensor or a sensor capable of detecting one or more of temperature, light and humidity. It should be appreciated that the nature of the sensor and what it detects can vary in dependence on the location and function of the sensor network. The sensors can be regarded as nodes. These sensors are connected together by connections 14. The connections can be wired connections, wireless connections or even combinations of the two. In a given network, the nodes may not all be connected together in the same way and may use a plurality of different connection methods. The wireless connection can be for example long range or short range, radio, infra-red, Bluetooth or any other suitable technology. The wired connection can be for example a cable, electrical power cables or Ethernet cables. Each node is directly connected to at least one other node, or at least has the ability to connect to at least one other node. The connections can be in any form. For example one node may be a control node to which each of the other nodes are connected or they may be connected in a chain or in any other suitable arrangement. One possible way to interconnect the nodes is an ad hoc mesh network.

It should be appreciated that the sensors can be any suitable sensor and on any scale. For example embodiments of the present invention can be used with networks on the scale of a city or a country as well as the more local example described in relation to FIG. 1. The sensor network may be on a smaller scale to the arrangement shown in FIG. 1 and may for example be incorporated in a device etc.

The sensors may be close together or spaced apart by a few meters to hundreds of kilometres or a mixture thereof.

By design, some of the links in sensor networks are point-to-point reliable and some are point-to-point un-reliable. Some of the applications require predictable end-to-end reliability service, which is currently achieved by end-to-end reliability methods that may inefficiently use already available abilities of the underlying links.

It should be appreciated that the network can be a network other than a sensor network. Embodiments of the present invention may be used in any network where there are a plurality of nodes which are connected together in a network.

Embodiments of the present invention may be implemented in the context of the exchange of data between components in a device. The device may be any suitable device for example a mobile device or a terminal. Embodiments of the invention can be used in multi-modular network architectures or the like.

FIG. 2 shows a mobile device 20 in which embodiments of the invention may be incorporated. The mobile device 20 is a mobile telephone which has a host processor 30, a camera 34, a display processor 36, a display 38 and a cellular modem 32. The host processor 30 is connected to each of the camera 34, the cellular modem 32 and the display processor 36. The display 38 is connected to the display processor 36. Thus each of the elements shown in FIG. 2 can be regarded as being a node and that these nodes are connected together to provide a network. It should be appreciated that the mobile device of FIG. 2 can have additional and/or alternative nodes or fewer nodes than those illustrated. It should also be appreciated that the nodes of FIG. 2 can be connected together in any other alternative configuration, and that it is not necessary for all the pictured nodes to be present for the principles of the invention to be applied.

The mobile device may operate in accordance with MIPI (mobile industry processor interface) or in accordance with any other protocol or standard.

The device need not be a mobile device and can be any suitable device, fixed or mobile. The device can have any purpose and be of any size. Embodiments of the present invention can be applied to any device comprising a network of nodes.

Thus embodiments of the present invention may also be used in an environment where there is not only data exchange between one or more components in a device but also in the context of data exchange between two or more devices. Alternatively, embodiments of the invention can be used for the connection between two networks. The connection may be a wired or wireless connection. The networks maybe provided on respective different devices or may be accommodated on the same device.

In the context of FIG. 2, for example it may be required that data transmission from the host processor 30 to the cellular modem 32 be reliable (e.g. error correction and/or retransmissions applied) if the user is using a web browser or mobile banking application, whereas for example the “preview” image data shown on the display prior to taking a digital photograph with the camera, used by the user to frame the photograph in a desired way, may be considered a streaming application and reliability might not be required—thus the links from camera 34 to host processor 30 to display processor 36 to display 38 could be rendered un-reliable for this traffic.

It should be appreciated that embodiments of the invention can be used in any other suitable context where there is a reliable link and an unreliable link.

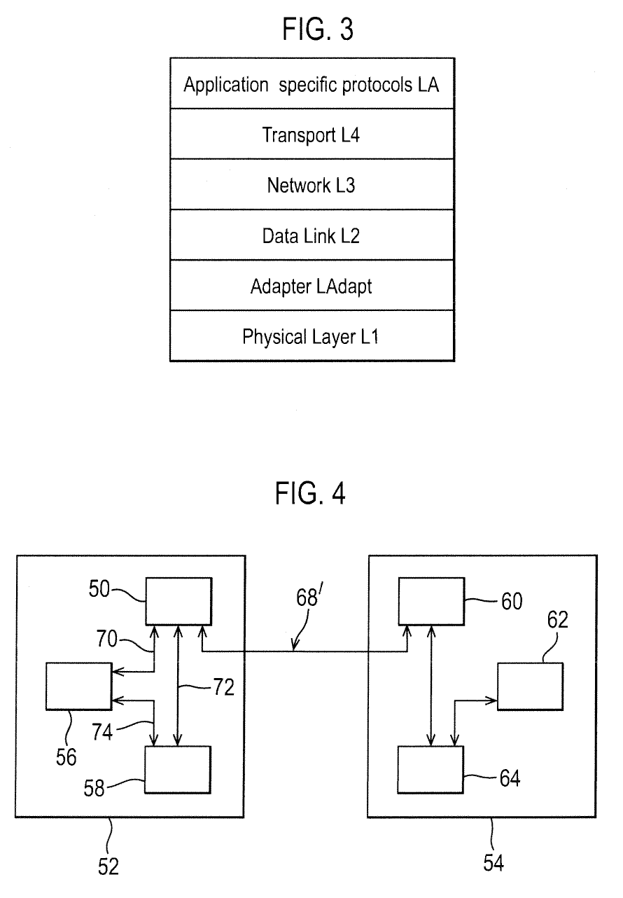

Reference is now made to FIG. 3 which shows the protocol stack of layers used in an embodiment of the present invention. The protocol stack may be in accord with the OSI SS7 model. In the arrangement shown in FIG. 3, there is an application specific protocol layer LA. This is on top of the transport layer L4. The transport layer L4 is in turn on top of the network layer L3 which is on top of the data link layer L2. This is in turn on the adapter layer LAdapt. The adapter layer is an interface between the data link layer L2 and the physical layer L1. In one embodiment of the invention, at least some if not all of the nodes in a network are arranged to have this protocol stack arrangement. The protocol stack arrangement of FIG. 3 could for example be used in the nodes of FIG. 2.

Reference is now made to FIG. 4 which a different environment in which embodiments of the present invention may be incorporated. FIG. 4 shows a first block 52 and a second block 54. The first block 52 has first, second and third sub-blocks 50, 56 and 58. The first sub-block 50 is arranged to communicate with the second and third sub-blocks 56 and 58 via respective connections 70 and 72. The second block 54 has first, second and third sub-blocks 60, 62 and 64. The first sub-block 50 and 60 of each block are arranged to communicate via connection 68. In the arrangement of FIG. 4, the two blocks may comprise two devices which each have a plurality of nodes. In another embodiment, the two blocks may comprise two modules of the same device, with each module comprising a plurality of nodes. In yet another embodiment of the invention, the two blocks may comprise different networks with each network comprising a plurality of nodes.

Embodiments of the invention can be used in a wide range of applications, including the ones discussed above, as well as:

an application engine; camera; display; memory or other data storage; links between modules or nodes; graphics; multimedia accelerator; modems—wireless or wired; or any other suitable application

In one embodiment of the invention independent routing trees for E2E reliable and non-reliable connections are created, maintained and used. The method separates treatment of reliable and non-reliable flows at the routing level, which in fact results in creation of two overlay networks on top of the existing link infrastructure.

For that the network layer functionality of the node performs an additional verification of the E2E reliability status of data flow and signals the obtained reliability requirements of the flow to the Data Link layer L2 of the corresponding link. A bit is added to the network layer header, which is used for indicating whether the reliable or non-reliable path has to be selected for a given flow. In one modification, the information may indicate that a reliable, non-reliable or either path may be selected. This might require two bits. In alternative embodiments of the present invention, this information may be provided in the body of the packet, rather than the header.

In the alternative, this information may obtained from the already defined fields, for example, based on some defined attribute, a decision would be made as to whether a reliable or unreliable path is to be used. For example, the decision could be made on the basis of the specified traffic class, the flow identity, and the required quality of service or the like. In some embodiments of the invention, the decision could be made on the basis of more than one piece of information. In this alternative, intermediate nodes between the end nodes may store a definition of the rules on how to process packets that match to the predefined criterion. For example for traffic class X, all flows for a given pair of source and destination nodes (that is a given point-to-point connection) the connection is preferably unreliable. The combined (C) class links can be used to perform load distribution between reliable and non-reliable link sets, since this type of link can carry either type of traffic.

The reliable or unreliable nature of a link may be a characteristic of the technology used and may not be determined by the traffic itself. In other words the nature of the link is relatively static. However, this may not be the case in all embodiments of the present invention. For example in some embodiments of the invention, a full scale combined type of link (Class C) may be provided which at all times can provide reliable and non-reliable treatment to the data flows depending on the flow requirements with substantially similar facility. Alternatively, in some embodiments of the invention a limited combined link may be provided, which can switch between the reliable and non reliable mode depending on one or more conditions.

When possible, the routing tables set the path over P2P reliable links for the flows that require E2E reliability, and over P2P non-reliable links for the other flows. This routing scheme may allow some embodiments to increase the efficiency of resource utilization. This embodiment uses the existence of the corresponding path types (reliable or non-reliable) for all source-destination pairs that want to set a connection.

In one embodiment of the invention, at least part of the routing tree or table is stored locally. The routing to at least the next node will be stored in each node. The routing table or tree can be created by an algorithm. Such algorithms are known in the art and will not be discussed further here. These algorithms can run locally on one or more nodes or can be run by a central node. The routing trees or tables can be relatively static or can be dynamic.

In one embodiment, a scheme of separate treatment of the data flows makes one traffic class P2P reliable and another P2P non-reliable. In this embodiment, there are two implementations—on top of P2P reliable link, and on top of P2P non-reliable links. A feature of this embodiment is that it has only link-local impact and on the network scale can be seen as combined link type—that at the same time is resource efficient for both reliable and non-reliable flow. A link in the class C may have a relatively high capacity so that the reliability or non-reliability classification does not have much of an effect on traffic. Alternatively a C link may originally be in class R (Reliable), where the retransmissions can be suppressed as described herein below. However there may be some corner cases where these links are available in the network due to some physical level solutions, e.g. when reliable and non-reliable links form a single channel such as in some cases in sensor networks. The network links can thus be divided onto three groups: reliable (R), non-reliable (N), and combined (C); as it is illustrated in the example network topology in FIG. 5.

In FIG. 5, a source node 80 is connected to a destination node 82 via a network of nodes 81. The network of nodes 81 has seven nodes 84-96. The source node 80 is connected to the first node 84 via a reliable connection. The first node is connected to a second node 94 via a non reliable connection, a third node 90 via a reliable connection and a fourth node 86 via a combined link. The second node 94 is connected to the fourth node 86 via a non reliable connection and to a fifth node 96 via a reliable connection. The third node 90 is connected to the fourth node 86 via a combined link and to a sixth node 92 via a reliable connection. The fourth node 86 is also connected to the fifth node 96 via a non reliable connection, to the sixth node 92 via a reliable connection and to a seventh node 88 via a combined link. The fifth node 96 is also connected to the seventh node 88 via a non reliable connection. The sixth node 92 is also connected to the seventh node 88 via a reliable connection. The seventh node 88 is also connected to the destination node 82 via a combined link.

Thus it is possible to route traffic from the source node to the destination node using only completely reliable connections, mostly unreliable connections or a combination thereof.

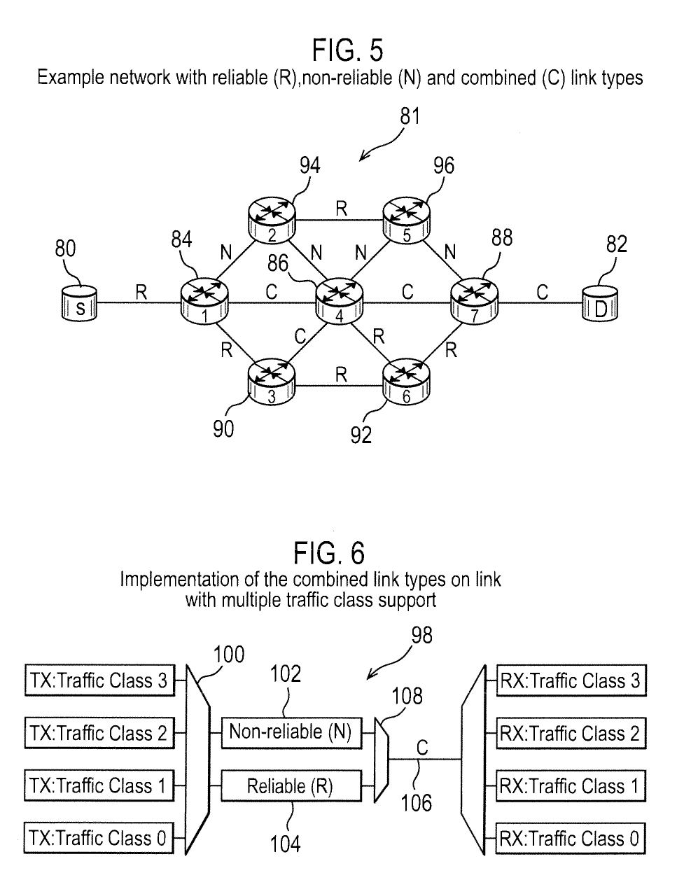

In one embodiment of the invention only the transmitter side of the link requires modification and can well coexist with any traffic prioritization and scheduling schemes deployed on the given link. For example, FIG. 6 illustrates how the combined link can be deployed on a link with four traffic classes. For example, there are four traffic classes 0, 1, 2, 3 . . . . Each of these classes is determined if it is to be reliable or unreliable. The transmitting node 98 will have a switch 100 (multiplexer for example) which directs traffic to the next node depending on whether the link has to be reliable or not. If the link has to be reliable, a transmitting node will send the data to a node with which the transmitting node has a reliable or combined link. If the link is to be unreliable, the transmitting node will send the data on a non reliable or combined link to the next node. In the example of FIG. 6, the combined link is being used. FIG. 6 schematically shows the data as requiring either a reliable link 104 or non reliable link 102 in the first instance. The reliable and non reliable links are shown as multiplexing onto a combined link 106 via a switch 106. This then provides a connection to the receiving node.

Embodiments of the invention can be implemented so that it only affects the link where it is deployed.

Embodiments of the present invention can be implemented in a system where every traffic class has its own reliability provision module that includes replay buffer and ACK/NACK mechanisms.

The same principle applies for P2P reliable links in sensor networks, where the proposed scheme can be used as an extension or replacement of the existing P2P reliability method.

In the case when the proposed scheme is used as an extension of the P2P reliable link, the scheme provides P2P unreliable treatment to the traffic of certain connections on top of P2P reliable link. Embodiments of the invention are able to provide compensation for resource losses introduced by P2P reliability mechanism. In this way the corresponding link is made easy tunable to be P2P reliable and non-reliable, as if it were two logically separated links.

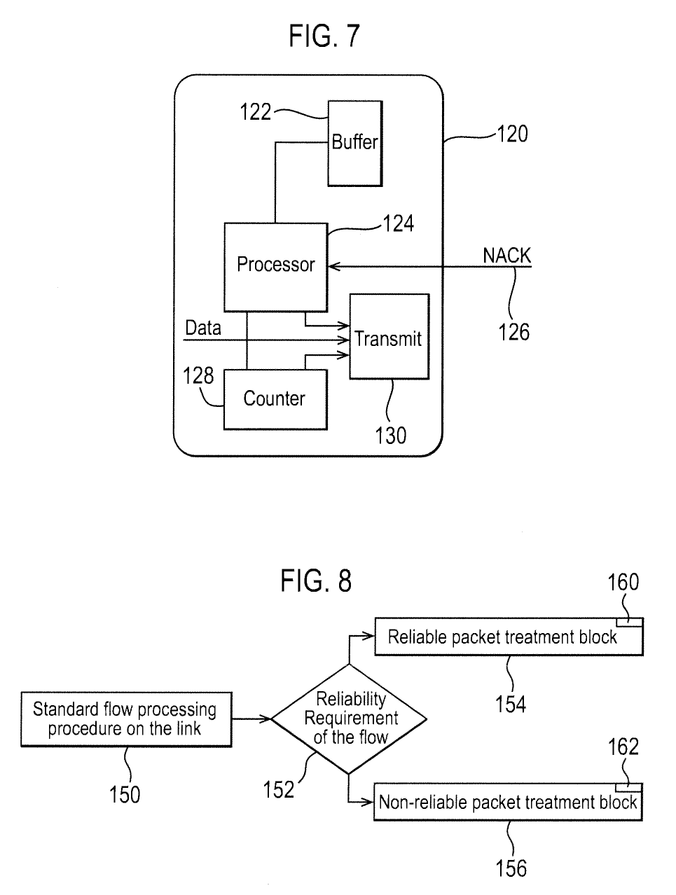

For that the following modifications of the transmitter side are performed, as illustrated schematically with reference to FIG. 7 which shows a transmitting node embodying the present invention. The replay buffer 122 for non-reliable traffic may be configured to be zero-size. In other words, the replay buffer 122 is not used for unreliable traffic. In addition the non-reliable traffic class has to implement another reaction to any NACK (negative acknowledgement) signals. In the reliable mode, the transmitter might start retransmitting a packet from the reply buffer 122 in response to the NACK signal. In the non-reliable mode, the processor 124 of the transmitter receives the NACK signal 126 and modifies the sequence number counter 128 to the value expected by the receiver, so that a “reliable” receiver will get an impression that a retransmission is happening, when transmit part 130 sends a new portion of data. In this way, losses are hidden from the receiver. In particular, this is advantageously done under the control of the processor 124.

In more detail, in reliable transmission mode, the sequence numbers are used for controlling that all packets are delivered. So every new packet (frame) gets own sequence number based on the following rule:

### New_seq_num=(last_seq_num+1)% length of the counter

Sequence numbers are reused with a certain interval, the length of which is defined by the length of the corresponding counter at the end points and lengths of the corresponding field in the packet header. The NACK frame informs sender about last correctly received frame by providing its sequence number. As there could be some data transmissions for each traffic class after the last correctly received packet, the retransmission of these packets should be initiated and of course the retransmitted packets must have the same sequence number as if the packets were just “delayed” original packets.

Referring to FIG. 8, this shows the functionality of a transmitting node embodying the present invention. In block 150, there is a standard flow processing procedure on a link. In block 152, a decision in made for the flows of block 150 as to the reliability requirement of the flow. If the flow requires reliable treatment, then it is passed to reliable flow treatment block 154 whilst if the flow requires non reliable treatment, it is passed to block 156.

Inside the reliable flow treatment block, there is a deciding stage 160 that determines if sufficient reliable-class link resources are available. Responsive to them being available, the flow is routed to these links. Responsive to them not being available, available non-reliable links are rendered reliable by implementing protocol-level error correction measures (as is known in the art), and subsequently the flow is routed to these links.

Inside the non-reliable flow treatment block, there is a deciding stage 162 that determines if sufficient non-reliable link resources are available. Responsive to them being available, the flow is routed to them. Responsive to them not being available, available reliable links are rendered non-reliable using the method described above, and subsequently the flow is routed to these links.

In one embodiment, the rendering of reliable links non-reliable and/or rendering of non-reliable links reliable may also be done responsive to the prevailing link utilization status, even if neither class of link is used to full capacity.

In embodiments of the invention there are the following scenarios:

1) implementing a reliability control feature for each traffic class individually;
2) doing it independently of the traffic classes (so after traffic multiplexer) and just allow the association of some traffic classes or individual packets with a certain reliability guarantee.

In some embodiments of the present invention, non-reliable traffic may have priority over reliable traffic in case when both traffic classes have something to send. This rule is based on the following reasons: in most cases non-reliable treatment of the data is selected because of its high urgency or priority. Moreover one reason why both traffic classes might want to send data at the same time, is due to replay event in reliable traffic, and in this case in order to not impact the original scheduling the non-reliable traffic should go first and use its slot for data transmission.

Some embodiments of the invention define principles of routing based on reliability requirements of the flows and a way of creating links that supports both modes of P2P reliability (combined links). Embodiments of the invention may also provide an efficient traffic distribution on top of the defined routing scheme. Embodiments of the present invention may require for traffic distribution, the presence of multiple paths to the destination. There is a number of prior art methods known for multi-path calculation on a given tree of links. One of these methods may be used in embodiments of the invention.

In embodiments of the present invention, the selected multi-path calculation method has to be used twice—first for all links marked with C and R, and then for all links marked with C and N. As a result there is a first set of paths that consist of only C links (these paths get reliability index C), a second set of paths that consist of C and R links (reliability index R), and paths that consist of C and N links (reliability index N). As a result, the routing tables contain multiple paths to the destination, where each path record is defined by the length (calculated based on the defined metric type), and the reliability status (R/N/C).

For example, in the network shown in FIG. 5, the first node 84 has three paths to the destination node 82—via node 94 with length 4 and index N (suitable only for non-reliable traffic); via node 90 with length 2 and index C (for all kinds of traffic); and via node 86 with length 3 and index R (only for reliable traffic).

Nodes that have access to more than one path to the destination use the following rules for distributing traffic over available paths. The reliable traffic is forwarded via path(s) marked with R or C, and non-reliable flows go via N or C. If two types of paths (e.g. R and C) are presented in the available set, then reliable and non-reliable flows may be clearly separated between the available directions. If there is more then one path with the compatible reliability status, the traffic with corresponding reliability status is distributed proportionally to the path length.

An example of a method to accomplish this is given in the following. The sum of all lengths is calculated, and if the sum exceeds the maximum number of destination port IDs (e.g. this number may be 32 in some embodiments), then the normalization coefficient is used The flow route is selected based on value that remains from dividing destination port ID by modulo of the sum of the lengths (and normalized if needed), as every alternative path is associated with the corresponding subset of remainders. This way a proportional split of the traffic is achieved and at the same time a guarantee that traffic of the same connection will always follow the same path (which is important for preventing packet reordering) is also achieved.

This is a mechanism for fair traffic distribution between the available paths to be inversely proportional to the path length. This way statically (and in same cases semi-dynamically) distributes individual flows addressed to the same destination node, but different ports (e.g. a number of applications running in parallel), and they are distributed proportionally over available paths to destinations.

By way of example consider FIG. 5 and the pair of source 84 and destination 82 nodes. Assume that node 84 send three reliable flows to node 82, addressed to ports 4, 7, 21 (out of 32 ports of the node). For simplicity of the example assume that path via node 90 has status R (not C) and length 2, and as in original case the path via node 86 is R and has length 3.

Based on that the total sum for reliable transmission is 5, where remainder values 0 to 2 are associated with path via node 90 and remainder values 3 and 4 are associated with the path via node 86. As a result flow to port 4 will go via node 86 (4%5=4), and flows for ports 7 (7%5=2) and 21 (21%5=1) will go via node 90.

Some embodiments of the invention may provide the advantage in that there is a flexible management of the E2E reliability status of connections in the target network types, which is useful for providing applications with a predictable Quality of Service QoS. Some embodiments of the invention may also improve the efficiency of the underlying links' resource utilization and provide a mechanism for efficient load distribution in the network, which allows a reduced buffer size at the network switches, minimizes E2E delay and prevents link blocking.

In one embodiment of the invention a so-called reliable link could be made non-reliable. This could be done in response to a triggering event. As a triggering event there is lot of options, for example, when one traffic class require reliable service (e.g. signalling data), and another class requires unreliable treatment (e.g. streaming with hard guarantees). A threshold option is also possible. For example a link may act as a reliable link while the number of requests for non-reliable service is below a certain threshold, and be switched to N mode when the threshold value is exceeded.

It should be appreciated that aspects of the present invention may be implemented in some embodiments of the invention in software or by computer programs which may be provided on a computer program carrying media.

1. A network of nodes comprising:
a plurality of nodes, at least one node being connected to at least one other node,
wherein a link between two nodes is classified as supporting reliable class traffic, as supporting unreliable class traffic or as supporting both reliable class traffic and unreliable class traffic.

2. A network as claimed in claim 1, wherein said reliable class traffic is such that a mechanism is provided to ensure that said reliable class traffic is received correctly by a receiving node.

3. A network as claimed in claim 2, wherein said mechanism comprises resending of reliable class traffic if it is not received correctly by said receiving node.

4. A network as claimed in claim 2, wherein said mechanism comprises coding reliable class data transmitted by a transmitting node to said receiving node.

5. A network as claimed in claim 1, wherein said unreliable class traffic is such that no mechanism is provided for ensuring that said unreliable class traffic is always correctly received by a receiving node.

6. A transmitting node, said transmitting node arranged in use to be connected to a receiving node with a reliable link therebetween, said transmitting node comprising a processor configured to suppress retransmission of data to said receiving node.

7. A transmitting node as claimed in claim 6, comprising a retransmission buffer, wherein said processor is configured to configure the retransmission buffer to a zero size.

8. A transmitting node as claimed in claim 6, comprising an input configured to receive a signal from said receiving node indicating non receipt of data from said transmitting node, said processor being configured, in response to said signal to modify the sequence number of packets subsequently sent by said transmitting node.

9. A transmitting node as claimed in claim 8, wherein said processor is configured to modify the sequence number such that said sequence number is modified to the sequence number expected by the receiving node.

10. A transmitting node as claimed in claim 6, comprising an input configured to receive a signal from said receiving node indicating non receipt of data from said transmitting node, said processor being configured, in response to said signal, to send a packet, empty of said data, to said receiving node.

11. A transmitting node as claimed in claim 10, wherein said empty packet comprises a sequence number.

12. A method of routing traffic in a network from a source node to a destination node via at least one node, each node being connected to at least one other node by a connection, wherein each connection is classified as supporting a first type of communication, a second type of communication or both the first type of communication and the second type of communication, said method comprising:
defining a routing table comprising information defining a plurality of paths between said source and destination nodes, said information defining for each path if said path comprises connections supporting the first type of communications, the second type of communications or both first and second type of communications.

13. A method as claimed in claim 12, wherein said information further comprises for each path the length of said path.

14. A method as claimed in claim 13, wherein said length is defined by the number of nodes between the source and destination nodes.

15. A method as claimed in claim 12, comprising:
using at least one path comprising connections supporting both said first and second type of communications to provide load distribution between said paths.

16. A method as claimed in claim 15, wherein using of said at least one path comprising connections supporting both said first and second type of communications is carried out where there is more than one path with connections supporting the required first or second type of communications, selecting the said at least one path in dependence on the load on said more than one paths.

17. A method comprising:
transmitting to a receiving node via a reliable link node,
suppressing, in response to a determination that the transmitting has not been successful, retransmission of data to said receiving node.

18. A method as claimed in claim 17, wherein suppressing retransmission of data is in response to receiving an indication from said receiving node that data transmission has not been successful.

19. A method as claimed in claim 17, wherein suppressing comprises configuring a retransmission buffer to a zero size.

20. A method as claimed in claim 17, comprising receiving a signal from said receiving node indicating that the transmitting has not been successful and suppressing comprises modifying the sequence number of packets subsequently transmitted to said receiving node.

21. A method as claimed in claim 20, comprising modifying the sequence number such that said sequence number is modified to the sequence number expected by the receiving node.

22. A method as claimed in claim 17, comprising receiving a signal from said receiving node indicating that the transmitting has not been successful and said suppressing comprises sending a packet empty of data to said receiving node.

23. A method as claimed in claim 22, wherein said empty packet comprises a sequence number.

24. A transmitting node, said transmitting node comprising:
means for connecting said node to a receiving node with a reliable link therebetween; and
means for suppressing retransmission of data to said receiving node.

25. A node comprising:
a first subunit configured to decide on a reliability required on a flow;
a second subunit configured to provide a reliable flow treatment; and
a third subunit configured to provide a non-reliable flow treatment, wherein said first subunit is configured to provide a received flow either to the first subunit or the second subunit in dependence on a decision made by the first subunit on the required reliability.

26. A node as claimed in claim 25, wherein said second subunit is configured to decide if there are sufficient reliable links available.

27. A node as claimed in claim 26, wherein said second subunit is configured to route a flow to reliable links if available and if not to unreliable links, said unreliable links being rendered reliable.

28. A node as claimed in claim 25, wherein said third subunit is configured to decide if there are sufficient unreliable links available.

29. A node as claimed in claim 26, wherein said second subunit is configured to route a flow to unreliable links if available and if not to reliable links, said reliable links being rendered unreliable.

30. A method comprising:
deciding on a reliability required on a flow;
if, the flow requires a reliable flow treatment, providing a reliable flow treatment; and
if the flow requires a non-reliable flow treatment providing a non-reliable flow treatment.

31. A method as claimed in claim 30, comprising deciding if there are sufficient reliable links available.

32. A method as claimed in claim 31, comprising routing a flow to reliable links if available and if not to unreliable links, said unreliable links being rendered reliable.

33. A method as claimed in claim 30, comprising deciding if there are sufficient unreliable links available.

34. A method as claimed in claim 31, comprising routing a flow to unreliable links if available and if not to reliable links, said reliable links being rendered unreliable.

35. A computer readable medium comprising:
computer executable components for defining a routing table comprising information defining a plurality of paths between source and destination nodes via at least one node, each node being connected to at least one other node by a connection, wherein each connection is classified as supporting a first type of connection, a second type of connection or both a first type of connection and a second type of connection, said information defining for each path if said path comprises first connections, second connections or both first and second connections.
